(19) United States
(12) Patent Application Publication
(10) Pub. No.: US 2015/0371282 A1
(43) Pub. Date: Dec. 24, 2015

(54) SERVING TARGETED ONLINE ADVERTISEMENT TO USERS WHO OWN AND LICENSE THEIR PROFILE INFORMATION

(71) Applicant: Ajit Pendse, Durham, NC (US)

(72) Inventor: Ajit Pendse, Durham, NC (US)

(21) Appl. No.: 14/747,432

(22) Filed: Jun. 23, 2015

Related U.S. Application Data
(60) Provisional application No. 62/016,265, filed on Jun. 24, 2014.

(51) Int. Cl. G06Q 30/02

(52) U.S. Cl. CPC G06Q 30/0269

(57) ABSTRACT

Personal information provided by a user may be stored in a secure data store or retrieved from a user's device for processing. The personal information may be homogenized to produce metadata indicating their interest in products or categories of products and services, their ability to buy, degree of need, and urgency of need to buy the product or service. The metadata may be free of all personal identifiable information. A unique identifier may be distributed to the user, e.g. to the user device, and in response to distribution of the unique identifier by the user, a third party advertisement server may present the unique identifier. In response to presentation of the unique identifier, the metadata may be provided to the third party advertisement server to generate a targeted advertisement for the user.

### PRIORITY

This application claims benefit of U.S. Provisional Application No. 62/016,265 filed on Jun. 24, 2014, entitled: METHOD TO SERVE TARGETED ONLINE ADS TO USERS WHO OWN AND LICENSE THEIR PROFILE INFORMATION, which is herein incorporated by reference in its entirety.

### COPYRIGHT NOTICE

©2014 Ajit Pendse. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### BACKGROUND OF THE INVENTION

Internet users are concerned that their personal data is being collected and owned and used (or abused) by large and small companies including ad-servers and ad companies for the purposes of profiling and serving users with targeted ads. The disclosure that follows solves this and other problems.

### SUMMARY OF THE INVENTION

The following is a summary of the invention in order to provide a basic understanding of some aspects of the invention. This summary is not intended to identify key/critical elements of the invention or to delineate the scope of the invention. Its sole purpose is to present some concepts of the invention in a simplified form as a prelude to the more detailed description that is presented later.

Personal information provided by a user may be stored in a secure data store or retrieved from a user's device for processing. The personal information may be homogenized to produce metadata indicating their interest in products or categories of products and services, their ability to buy, degree of need, and urgency of need to buy the product or service. The metadata may be free of all personal identifiable information. A unique identifier may be distributed to the user, e.g. to the user device, and in response to distribution of the unique identifier by the user, a third party advertisement server may present the unique identifier. In response to presentation of the unique identifier, the metadata may be provided to the third party advertisement server to generate a targeted advertisement for the user.

Additional aspects and advantages of this invention will be apparent from the following detailed description of preferred embodiments, which proceeds with reference to the accompanying drawings.

### BRIEF DESCRIPTION OF THE DRAWINGS

FIG. 1 illustrates a system to serve targeted online ads to users who own and license their profile information.

FIG. 2 illustrates a process that may be performed by the network device of FIG. 1.

FIG. 3 illustrates a process that may be performed by the user device application of FIG. 1.

### DETAILED DESCRIPTION OF PREFERRED EMBODIMENTS

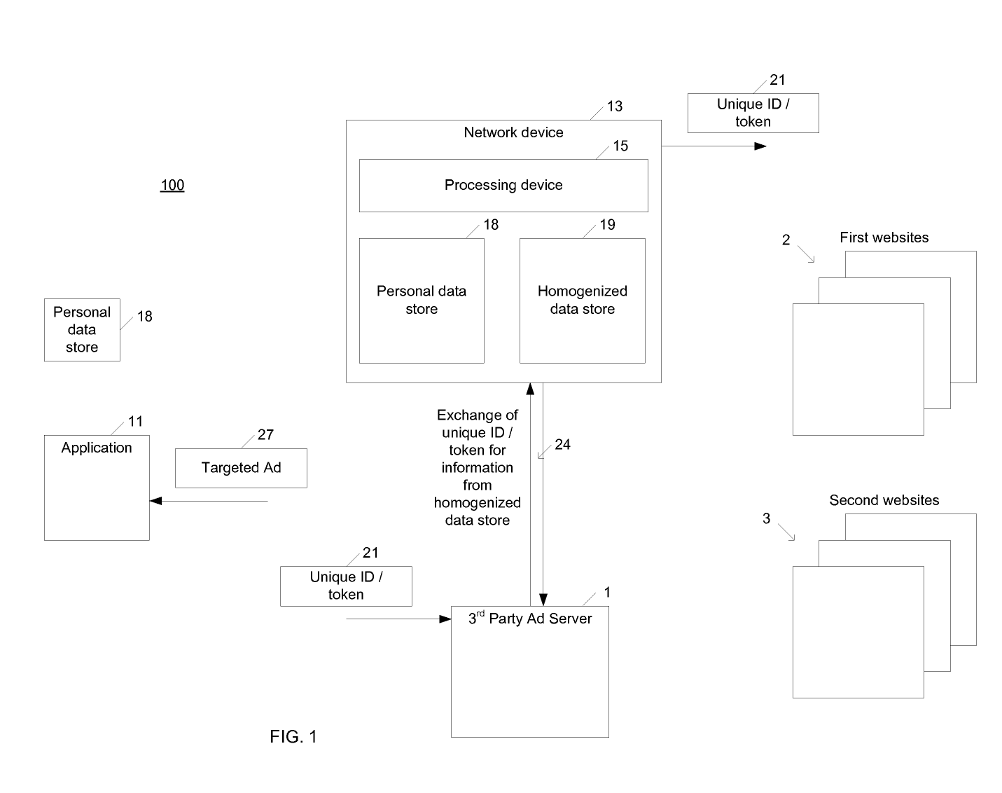

FIG. 1 illustrates a system to serve targeted online ads to users who own and license their profile information.

The system 100 includes a network device 13 including a processing device 15 for serving targeted online ads to users who own and license their profile information. The network device 13 may include one or more servers and one or more databases, which may be local or remote with respect to any of the servers. The system includes an application 11, e.g. a web browser, a mobile device application, or the like, or combinations thereof.

In an example, the application 11 includes web browser extension software that may prevent the browser from storing personal information in cookies and/or may implement siloing technology. The application 11, e.g. the web browser extension software, may guard the privacy of the user, limit the revelation of the user's identity and tracking of the user by websites that the user may visit while browsing the internet.

In an example, the application 11, e.g. the web browser extension software, may be configured to intercept, segregate and store cookies and trackers associated with each (first party) website, i.e. the domain and its subdomains visited by the user. The interception, segregation and storage of cookies may be enabled/disabled by a user, in an example. These intercepted cookies and trackers may include first party and third party cookies and trackers downloaded directly from the visited website or those generated by scripts or other programs such as Javascript or Flash downloaded from the website but executed in the user's browser. The application 11, e.g. the web browser extension software, may be configured to encrypt and/or store separately these intercepted cookies and trackers to disable retrieval or viewing by websites other than the one providing these cookies and trackers (i.e. they can be only be viewed/retrieved by the first party website). The application 11 may be configured to automatically delete all first and third party cookies and trackers associated with the visited website (domain and subdomain) responsive to a user input to close the application 11, e.g. closing the browser and/or a browser tab, unless overridden by the user.

A user may upload information to network device 13 via application 11. In an example, the information includes personal information such as browsing history (which may include search history), content from a user completing a profile, or the like. The processing device 15 may be configured to store the personal information in a personal data store 18. In an example, personal data store 18 may aggregate, e.g. collect and synchronize, data from the user device and other devices utilized by the user. As per the illustrated example, the personal data store 18 may be resident on a secure server of the network device 13; however, in other examples the personal data store 18 may be resident on a user device, such as a same user device of the application 11, or a different user device such as a Network Attached Storage (NAS) device.

The processing device 15 may be configured to homogenize the personal information to create metadata which does not contain personal identity information. In an example, the process includes an initial step of organizing the personal information into a user record. For instance, user-supplied information such as age, gender, income, hobbies, etc. and information sought such as goods or services from browsing history (which may include search history) or expressly requested by the user may be organized into a user record.

A homogenization algorithm may be applied in a subsequent step to correlate this user record to one or more of a predetermined set of profiles. In an example, the set of profiles is ten or more. An example of a profile type is “recent college graduate” which may be represented by a first value, e.g. a first number, letter, or combination thereof, another example is “rich suburban empty nesters”, which may be represented by a second different value. The homogenization algorithm may also assign values to product/service sought category by the user, the user's ability to buy the product/service, the degree of need, urgency of need, or the like, or combinations thereof. The assigned values may indicate a rating level from a set of alpha, numeric, or alphanumeric values.

The processing device 15 may store generated metadata, which may include the value(s) output from the homogenization algorithm, in homogenized data store 19. In an example, the processing device 15 may be configured to output a plurality of values responsive to applying the homogenization algorithm. The processing device 15 may assign a rating level to each one of a plurality of metrics based on the personal data. In an example, the metrics include at least one of ability to buy, degree of need, urgency of need. Ratings levels for each metric may be a plurality levels, such as three levels, e.g. three alpha, numeric, or alphanumeric, e.g. rating level A (highest), B, and C (lowest). The processing device 15 may output the rating levels in a predefined sequence. The sequence CAA may communicate low ability to buy, high degree of need, and high urgency, while the sequence AAB may communicate high ability to buy, high degree of need, moderate urgency. In an example, a plurality of sequences may be output, each one corresponding to one of a plurality of products and/or services.

In an example, the information uploaded by the application 11 includes homogenized information. The application 11 may be configured to homogenize the personal information and provide the homogenized information to the network device 13. The application 11 may use the previously described homogenization algorithm, in which case the uploaded homogenized information may include the output value(s). The processing device 15 may be configured to store the homogenized information in homogenized data store 19.

The processing device 15 may be configured to generate a unique identifier 21, i.e. one or more unique identifiers. Each unique identifier is associated with a portion of the homogenized data store that corresponds to the user. In an example, the generated unique identifier may include one or more of the output sequences alone or in combination with other values and/or a portion of the generated unique identifier may encode the values of the sequence. In an example, the processing device 15 may implement a tokenization process to generate a set of tokens associated with the unique identifier. A token is a randomized number, which is not reusable. A token from the set be passed by the application 11 to a third party ad server 1 in connection with a website access via the application 11, as will be explained in greater detail in the next paragraph.

The application 11, under control of the user, may access a website. In an example, the website access may be to first websites 2 that are not affiliated with the network device 13. As the user browses a page on the Internet, and the page is being rendered the browser may try to fetch an ad. In this case, the application 11 may pass the unique identifier 21 and/or one of the tokens from the set to the ad server 1 when the application 11 makes the request for the web ad. In an example, the unique identifier 21 and/or single token may be attached, e.g. appended, to a Uniform Resource Locator (URL) of the ad server 1 by the application 11.

After the third party ad server 1 obtains the unique identifier 21 and/or single token, an exchange 24 may take place between the network device 12 and the ad server 1. The ad server 1 may present the unique identifier 21 and/or single token to the network device 13. The network device 13 may identify information in the homogenized data based on the unique identifier 21. The network device 13 may pass the identified information to the ad server 1, enabling the ad server 21 to send a targeted ad 27 to the application 11. If a token was used, this would be a redemption of that particular token—a next request to ad server 21 would include a different token from the set.

In the scenario described above the website access was to the first websites 2 that are not affiliated with the network device 13. In an example, the website access may be to a server of the network device 13. The network device 13 may act as a proxy for a search by a third party search engine. In this case, the network device 13 may identify information in the homogenized data, pass the identified information to the ad server 1, enabling the ad server 21 to return a targeted ad 27 back to the network device 13. The network device 13 may then pass the search results from the third party search engine and the targeted ad 27 to the application 11. Also, the server of the network device 13 may provide webmail, online auction servers, or the like, or combinations thereof, instead of or in addition to acting as a proxy for a search by a third party search engine. In these cases, the server of the network device 13 may provide the requested content (webmail, auction information, or the like, or combinations thereof) and the targeted ad 27 to the application 11 Another similar scenario involves the website access to the second websites 3 that are affiliated with the network device 13 through the network device 13—the network device 13 may then pass the requested information from the second websites 3 and the targeted ad 27 to the application 11.

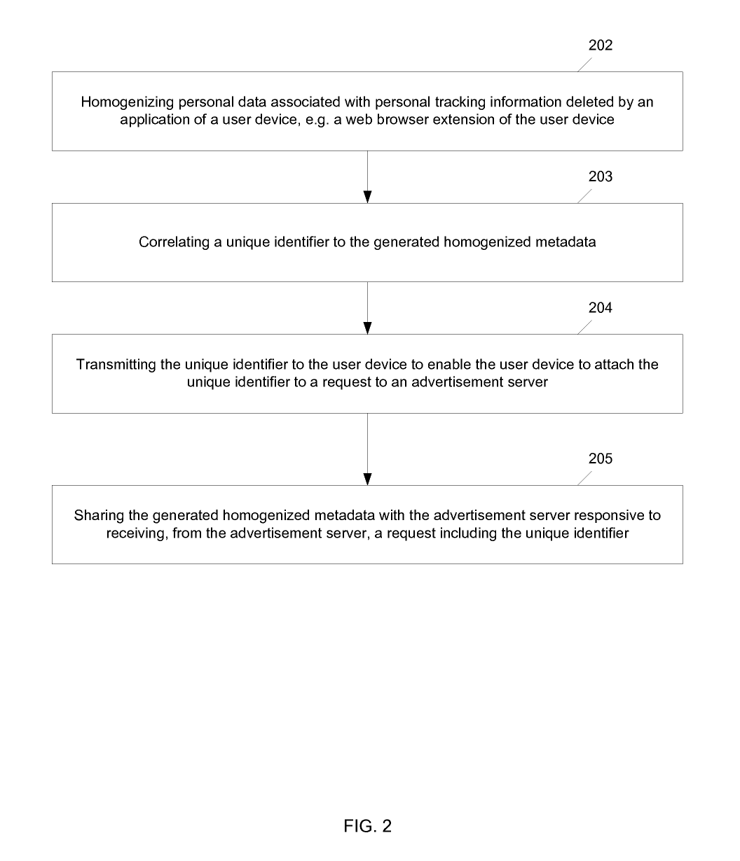

FIG. 2 illustrates a process that may be performed by the network device of FIG. 1.

In block 202, the network device 13 may homogenize personal data associated with personal tracking information deleted by an application of a user device, e.g. a web browser extension of the user device. In block 203, the network device 13 may correlate a unique identifier to the generated homogenized metadata. In block 204, the network device 13 may transmit the unique identifier to the user device to enable the user device to attach the unique identifier to a request to an advertisement server. In block 205, the network device 13 may share the generated homogenized metadata with the advertisement server responsive to receiving, from the advertisement server, a request including the unique identifier.

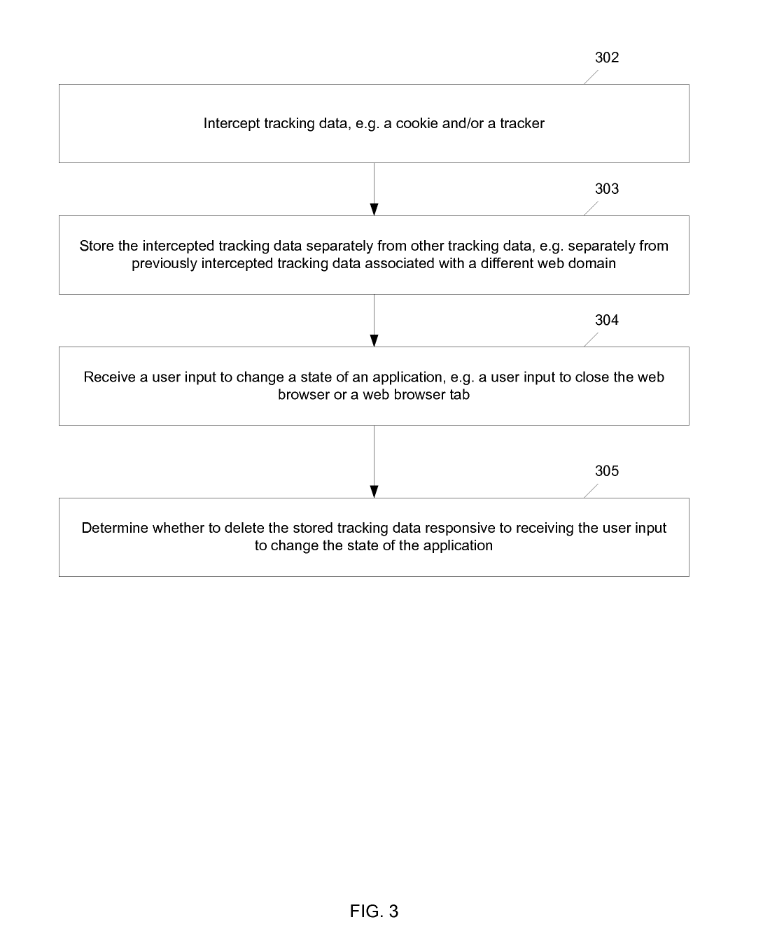

FIG. 3 illustrates a process that may be performed by the user device application of FIG. 1.

In block 302, the application 11 may intercept tracking data, e.g. a cookie and/or a tracker. In block 303, the application 11 may store the intercepted tracking data separately from other tracking data, e.g. separately from previously intercepted tracking data associated with a different web domain. In block 304, the application 11 may receive a user input to change a state of an application 11, e.g. a user input to close the web browser or web browser tab. In block 305, the application 11 may determine whether to delete the stored tracking data responsive to receiving the user input to change the state of the application 11.

It will be obvious to those having skill in the art that many changes may be made to the details of the above-described embodiments without departing from the underlying principles of the invention. The scope of the present invention should, therefore, be determined only by the following claims.

Most of the equipment discussed above comprises hardware and associated software. For example, the typical electronic device is likely to include one or more processors and software executable on those processors to carry out the operations described. We use the term software herein in its commonly understood sense to refer to programs or routines (subroutines, objects, plug-ins, etc.), as well as data, usable by a machine or processor. As is well known, computer programs generally comprise instructions that are stored in machine-readable or computer-readable storage media. Some embodiments of the present invention may include executable programs or instructions that are stored in machine-readable or computer-readable storage media, such as a digital memory. We do not imply that a “computer” in the conventional sense is required in any particular embodiment. For example, various processors, embedded or otherwise, may be used in equipment such as the components described herein.

Memory for storing software again is well known. In some embodiments, memory associated with a given processor may be stored in the same physical device as the processor (“on-board” memory); for example, RAM or FLASH memory disposed within an integrated circuit microprocessor or the like. In other examples, the memory comprises an independent device, such as an external disk drive, storage array, or portable FLASH key fob. In such cases, the memory becomes “associated” with the digital processor when the two are operatively coupled together, or in communication with each other, for example by an I/O port, network connection, etc. such that the processor can read a file stored on the memory. Associated memory may be “read only” by design (ROM) or by virtue of permission settings, or not. Other examples include but are not limited to WORM, EPROM, EEPROM, FLASH, etc. Those technologies often are implemented in solid state semiconductor devices. Other memories may comprise moving parts, such as a conventional rotating disk drive. All such memories are “machine readable” or “computer-readable” and may be used to store executable instructions for implementing the functions described herein.

A “software product” refers to a memory device in which a series of executable instructions are stored in a machine-readable form so that a suitable machine or processor, with appropriate access to the software product, can execute the instructions to carry out a process implemented by the instructions. Software products are sometimes used to distribute software. Any type of machine-readable memory, including without limitation those summarized above, may be used to make a software product. That said, it is also known that software can be distributed via electronic transmission (“download”), in which case there typically will be a corresponding software product at the transmitting end of the transmission, or the receiving end, or both.

Having described and illustrated the principles of the invention in a preferred embodiment thereof, it should be apparent that the invention may be modified in arrangement and detail without departing from such principles. We claim all modifications and variations coming within the spirit and scope of the following claims.

1. A memory device having instructions stored thereon that, in response to execution by a processing device, cause the processing device to perform operations comprising:
downloading a web browser extension to a user device to cause a web browser on the user device to delete personal tracking information;
homogenizing personal data associated with the personal tracking information to generate homogenized metadata, the homogenizing filtering personal identifiable information present in the personal data;
correlating a unique identifier to the generated homogenized metadata;
transmitting the unique identifier to the user device to enable the user device to attach the unique identifier to a request to an advertisement server; and
sharing the generated homogenized metadata with the advertisement server responsive to receiving, from the advertisement server, a request including the unique identifier.

2. The memory device of claim 1, wherein the web browser extension is configured to:
intercept a tracking object transmitted to the user device, the tracking object associated with a first web domain;
store the intercepted tracking object separately from a previously intercepted tracking object associated with a second different web domain; and
determine whether to delete the tracking object associated with the first web domain responsive to receiving a user input to change a state of the web browser.

3. The memory device of claim 2, wherein the tracking object comprises a cookie.

4. The memory device of claim 3, wherein the personal data includes the cookie.

5. A memory device having instructions stored thereon that, in response to execution by a processing device, cause the processing device to perform operations comprising:
obtaining metadata resulting from homogenization of personal data associated with personal tracking information deleted by an application of a user device;
correlating a unique identifier to the homogenized metadata;
transmitting the unique identifier to the user device to enable the user device to attach the unique identifier to a request to an advertisement server; and
sharing the homogenized metadata with the advertisement server responsive to receiving, from the advertisement server, a request including the unique identifier.

6. The memory device of claim 5, wherein obtaining the homogenized metadata further comprises receiving a communication over a network from an application operating on a remote user device.

7. The memory device of claim 5, wherein obtaining the homogenized metadata further comprises:
downloading an application to the user device to cause the application to delete the tracking information;
accessing the personal data via the downloaded application;
homogenizing the personal data responsive to accessing the personal data to create the homogenized metadata, the homogenizing filtering personal identifiable information present in the accessed personal data.

8. A method, comprising:
deleting personal tracking information stored by a browsing application responsive to a user input to change a state of the browsing application;
organizing personal data associated with the personal tracking information into a user record;
correlating the user record with a subset of a set of predetermined profiles;
generating homogenized metadata including a first value corresponding to the correlated predetermined profile(s) of the subset;
correlating a unique identifier to the generated homogenized metadata;
generating a set of randomized numbers associated with the unique identifier;
providing an unused randomized number from the set to the user device responsive to the user device attempting to fetch an advertisement from an advertisement server to cause the user device to append the provided randomized number to a Uniform Resource Locator (URL) associated with the advertisement server;
sharing the generated homogenized metadata with a third party responsive to receiving, from the third party, a request including said provided one of the set of randomized numbers.

9. The method of claim 8, further comprising:
assigning a rating level to each one of a plurality of metrics based on the personal data, wherein the plurality of metrics include at least one of ability to buy, degree of need, or urgency of need;
generating a plurality of second values based on the assigned rating levels, each second value corresponding to a respective one of the metrics; and
concatenating the second values according to a predefined sequence associated with the metrics to form at least a portion of the first value.
